(19) United States
(12) Patent Application Publication
(10) Pub. No.: US 2016/0299269 A1
(43) Pub. Date: Oct. 13, 2016

(54) RETROREFLECTIVE BIODEGRADABLE ELEMENT, COMPOSITE AND RELATED PRODUCTS

(71) Applicants: TEKSLA OY, Helsinki (FI); WALOON REFLECTOR SOLUTIONS OY, Vakkola (FI)

(72) Inventors: Elisa PARMANEN, Vakkola (FI); Eeva-Liisa RUOTSINSALO, Masala (FI)

(21) Appl. No.: 15/036,448

(22) PCT Filed: Nov. 15, 2013
(86) PCT No.: PCT/EP2013/073922

§ 371 Date: May 13, 2016

(51) Int. Cl. G02B 5/124; C09D 5/33; C09D 167/04; C08K 7/02; B29C 43/00; B29C 45/00; B29C 47/00; D01D 5/26; A41D 13/01; A42B 1/00; A41D 7/00; A41B 9/00; A41D 19/00; A41B 11/00; A41B 11/14; A41F 9/00; A41D 23/00; A41D 20/00; G02B 1/04

(52) U.S. Cl. CPC G02B 5/124; G02B 1/04; C09D 5/004; C09D 167/04; C08K 7/02; B29C 43/003; B29C 45/0001; B29C 47/0004; B29C 47/0014; D01D 5/26; A41D 13/01; A42B 1/00; A41D 7/00; A41B 9/00; A41D 19/00; A41B 11/00; A41B 11/14; A41F 9/00; A41D 23/00; A41D 20/00; B29K 2995/003

(57) ABSTRACT

A retroreflective element (10) in the form of a micro- or nano-sized prism produced from bio-based and biodegradable plastic polymers, such as polylactic acid (PLA) or polyglycolic acid (PGA) is provided. A plurality of retroreflective elements (10) are utilized for manufacturing of a reflective composite material (100), which, in turn, may be utilized for manufacturing of a multiplicity of various products. Retroreflective fibrous products, like yarns, threads and textiles may thus be produced. The composite (100) and/or elements (10) may be blended to any appropriate material and being further processed by spraying, spreading, printing, casting, molding, pressing and the like.

### FIELD OF THE INVENTION

Generally invention relates to reflective gear and production methods thereof. In particular, the present invention concerns biodegradable reflective materials and methods for further processing the same.

### BACKGROUND

Among the things that have a great impact on pedestrians and cyclists safety on the roads in limited or no light conditions is reflective gear. For example a pedestrian crossing a road and wearing a safety reflector can be noticed by a vehicle driver from about 100 meters distance farther than a pedestrian having no reflector. Reflective gear generally improves visibility of an object by about 100-200 meters depending on surroundings, utilization of far lights and driving conditions. Aforesaid distance in certain cases may be critical for avoiding traffic accident. A variety of solutions exist for common reflective gear, ranging from hard and soft pedestrian reflectors to reflective armbands and vests.

Hard prism reflectors are normally made of hard plastics, such as polystyrene, for example, and comprise a plurality of tiny sharp prisms molded therewithin. These reflectors are so called retroreflectors, wherein the prefix “retro” indicates the property of a reflector to immediately return light back to a light source without diffusing it, thus making the reflector more powerful. Soft hanging reflectors are typically produced of a polyvinyl chloride (PVC) membrane with prisms printed thereto. Pliable solutions, such as various reflective patches, appliques, stripes, fabrics and even reflective inks for direct screen printing onto fabrics are also known. For example, 3M Scotchlite trademarked products are composed of retroreflective lenses bonded to a variety of adhesives or fabric backings U.S. Pat. No. 6,110,558 thus discloses a retroreflective applique, comprising a monolayer of retroreflective optical elements embedded into a binder and a metal reflective layer disposed beneath the embedded portion of the optical elements, wherein the reflective layer is aluminium or silver and the optical elements are microspheres made of glass, non-vitreous ceramic composition or synthetic resin. The solution is limited by its applicability only in the form of applique, patch or label, attachable to any article of clothing.

Reflective thread, composed of a rectangular element comprising glass beads therewithin and laminated such, to form a substantially circumferential profile, and method of manufacturing thereof are disclosed in patent publications WO/2010/090,363 and WO/2010/126,189.

U.S. Pat. No. 5,804,275, in turn, discloses a reflective fiber product having reflective flat threads, in each of which triangular, pyramid-like or otherwise shaped micro-prisms are consecutively and regularly disposed. Aforementioned flat threads can be manufactured from polyester, polyvinyl chloride and acrylic plastics, and can be combined with natural or synthetic fiber threads to form woven or knitted reflective fiber products.

Abovementioned solutions are still constrained with several limitations, the major one being difficulty of disposing and/or recycling thereof. Whereas wearing apparel may be safely disposed via landfill or clean burning, most of reflective materials integrated and/or attached thereto have to be removed before such disposal, since those reflecting materials contain toxic or otherwise non-disposable particles, such as metals. From the other hand, each existing solution represents a specific product, comprising optically reflective particles in a particular arrangement. Such regularity in disposition of the reflective particles, exploited for imparting retroreflectivity to a final product, harshly limits application potential for safety reflector solutions available so far.

### SUMMARY OF THE INVENTION

An objective of the present invention is to at least alleviate each of the problems set forth in the background section by providing a versatile and ecological solution for imparting retroreflectivity to a selected object, independent on shape and/or dimensions thereof. The objective is achieved by implementing a retroreflective biodegradable element; a composite material comprising a plurality of said elements; a method for imparting a property of retroreflectivity to a selected object or a number of selected objects by applying the reflective composite material onto said object or a number of objects; and a selection of retroreflective products manufactured on the basis of said material, methods of manufacturing and use thereof.

A retroreflective element in the form of a micro-prism is thus provided. In the preferred embodiment said element is manufactured from bio-based and biodegradable plastic polymers.

In some embodiment the retroreflective element may be downsized to nano-scale.

In another aspect of the invention a reflective composite material is provided, comprising a reinforcing component and a binder, wherein the reinforcing component is represented by a plurality of retroreflective prismatic elements, whose disposition within the binder is random

In further aspect a method for imparting a property of retroreflectivity to a selected object or a number of selected objects is provided, implemented by applying the reflective composite material onto said object or a number of objects, wherein the composite material is utilized per se or provided as a blend with a suitable material, selected to optimize the properties of the reflective composite with regards to a particular utility application.

In still further aspect a method for producing a reflective product from the reflective composite is provided by blending the composite with a suitable material selected to optimize the properties of the reflective composite with regards to a particular utility application.

In some embodiment a method for producing a reflective fibrous product in the form of a staple fiber and/or a filament is provided. In some other embodiments, methods for producing a reflective fibrous product in the form of a single yarn, a plied yarn and a core-spun yarn are provided.

In further embodiment a method for producing a reflective molded product from the reflective composite is provide by blending the reflective composite with a moldable polymer and further subjecting the resulted blend to a molding process including, but not limited with injection molding, extrusion molding, compression molding and matrix molding.

In still further embodiment a method for producing a substantially liquid reflective product selected from the group consisting of inks, paints, dyes, varnishes and coatings is provided, implemented by admixing the reflective composite into an appropriate solvent, dye, paint, varnish or coating composition.

In still further embodiment a method for producing a reflective product in the form of aerosol spray is provided, implemented by dispensing the reflective composite in air or inert gas.

In further aspect a reflective fibrous product is provided. In some embodiments, the reflective fibrous product is implemented in the form of a single yarn, a plied yarn and a core-spun yarn. In some other embodiments, said reflective fibrous product further is implemented to further comprise any conventional, natural or synthetic fiber-, filament- or yarn components, integrated to or combined with the reflective component in any combination possible.

In further embodiments the reflective fibrous product is configured as a thread for sewing, embroidery, crocheting or knitting, a cord, a rope or a cable.

In some aspect a reflective textile article, produced by weaving or knitting the reflective fibrous product is provided, selected from the group consisting of plain and textured woven fabric, plain and textured knit fabric, technical fabric, lace, braids, ribbons, stripes, trims and ornaments.

In some aspect, a reflective article of wearing apparel, manufactured from the reflective textile article is provided, selected from the group consisting of garments, headwear, beach- and underwear, gloves, pantyhose and socks, textile parts for the footwear, and textile accessories, such as belts, scarves, shawls, headbands and the like.

In some aspect, a substantially liquid reflective product is provided, selected from the group consisting of inks, paints, dyes, varnishes and coatings. In some embodiment a substantially liquid reflective product is configured as a reflective ink for printing on banknotes, vouchers, tickets and official documents.

In some aspect, use of the aerosol spray is provided for generating reflective coatings on durable and/or self-adhesive supports, including, but not limited with repairing patches, self-adhesive labels and stickers.

The utility of the present invention arises from a variety of reasons depending on each particular embodiment thereof. First of all, the invention enables production of environmentally friendly products, such as wearing apparel, for example. Biocompatibility of the reflective composite material provided in accordance with some aspect of the invention renders the products manufactured on the basis thereof attractive alternative to existing safety reflector solutions. For example clothing items provided with integrated or attached safety reflective patches, comprising retroreflective elements in accordance with one aspect of the invention, become completely biocompatible, hence the need of removing safety reflectors from the clothes before recycling thereof is eliminated. Degradability rates of the reflective material can therefore be adjusted to match that of the item(s) said material is applied to. For example, degradability rate of an exemplary reflective fiber product, in accordance to some embodiment, may be adjusted such, to match degradability rate of an e.g. polyester fiber, commonly utilized for fabricating clothes.

The reflective fibrous product is non-toxic; the items manufactured therefrom may be utilized in direct contact with skin and washed normally.

Retroreflective elements, as disclosed herewith, neither alter properties nor visual appearance of an item they are disposed or integrated to. At daylight said elements cannot be detected within an item by naked eye. The reflective fiber product still fulfills safety requirements set up by the CE EN 13356 Reflectivity standard for visibility accessories for non-professional use.

The invention exhibits exceptional versatility in terms that the retroreflective elements and the related composite material may be blended practically into any appropriate solution, solvent, blend and/or mass for further use.

By the term “bio-based” we refer to a plastic polymer, either directly derived from renewable biomass or produced from monomers derived from the biomass. By the term “biodegradable” we refer to a material, which can be completely broken down by micro-organisms found in the environment in a reasonable timeframe.

The expression “a number of” refers herein to any positive integer starting from one (1), e.g. to one, two, or three.

The expression “a plurality of” refers in the context of this document to indicate such a number of elements, when counting thereof is either impossible or extremely difficult, i.e. utilized in a meaning of “numerous”.

The term “element” may herein refer also to a multi-part element with multiple functionally and optionally also physically connected elements in addition to single-part or integrated elements.

Different embodiments of the present invention will become apparent by consideration of the detailed description and accompanying drawings.

### BRIEF DESCRIPTION OF THE DRAWINGS

FIG. 1 schematically illustrates an exemplary retroreflective prismatic element in accordance with some embodiment.

FIG. 2 schematically illustrates a reflective composite in accordance with some embodiment.

FIG. 3 is a block diagram illustrating versatility of the inventive concept.

### DETAILED DESCRIPTION OF THE EMBODIMENTS

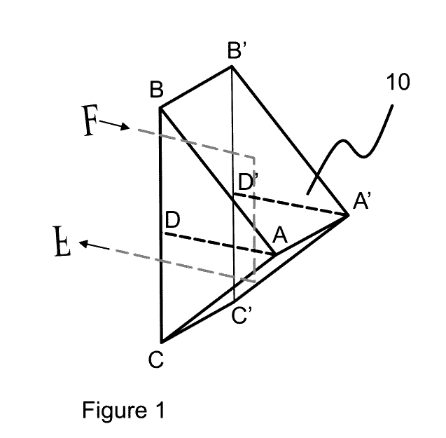

Detailed embodiments of the present invention are disclosed herein with the reference to accompanying drawings. A retroreflective element 10 is provided in the form of a prism. A three-dimensional object fulfills the definition of a prism, whether it has two bases, constituting identical and/or congruent polygons and similarly oriented in parallel planes such, that the prism has a number of flat lateral (side) faces in the form of rectangles and the same cross-section all along its length. The number of lateral faces in a prism corresponds to the number of sides at each base thereof. FIG. 1 illustrates an exemplary element 10 in the form of a triangular prism. It is generally known that triangular prism is a three-dimensional object, whose bases constitute equal triangles, similarly oriented in parallel planes so the prism has flat side faces in the form of parallelograms and the same cross-section all along its length. Bases of such prism preferably constitute equilateral triangles, with all three sides having the same length; however, bases of the prism 10 may also constitute an isosceles triangle, having only two sides of equal length. Prismatic element 10 shown on FIG. 1 therefore has two identical triangular bases ABC and A′B′C′ and three parallelogram-shaped side faces AA′C′C, AA′B′B and BB′C′C, wherein at least two side faces have equal dimensions. The retroreflective element 10 the form of a triangular prism is shown by the way of example, not limitation. The element 10 may also be represented by a prism, whose bases constitute equal rectangles, pentagons or octagons, for example; the prismatic element 10 therefore would be represented by a rectangular, pentagonal or octagonal prism, respectively. External appearance of the prism may therefore vary, as long as said prism preserves its retroreflective properties.

Each retroreflective element 10 is manufactured from bio-based and biodegradable plastic polymer, such as polylactic acid (PLA) or polyglycolic acid (PGA). Aforementioned polymeric compounds are derived from renewable resources and comprised of natural monomers. Apart from mentioned PLA and PGA polymers, elements 10 may be produced from derivatives and/or copolymers thereof, such as poly-lactic-co-glycolic acid (PLGA), for example.

PGA polymers are 20-30% stronger and withstand temperatures by about 20° C. higher in comparison to PLA polymers. Furthermore, those degrade in nature faster than PLA. Degradation rates of PGA polymers can still be adjusted by controlling a number of monomers (glycolic acids) therewithin. Lifespan of the retroreflective elements 10, produced from PGA, can thus be advantageously adjusted to match lifespan of other material(s) within a product, said reflective elements 10 are intended to be applied to.

Each retroreflective element 10 shown on FIG. 1 is represented by a prism dimensioned within micrometer range 0.01-1000, preferably 0.1-500. In some embodiments, the preferred dimensional range for each element 10 lies within 300-500 micron. Size of the element 10 may be reduced to nano-scale. Production of the elements 10 of macro-size, i.e. dimensioned within millimeter range and larger, is not excluded either. Numerical values as defined above are determined by the length of perpendicular bisector lines, which intersect angles between any two, equal in length adjacent sides of the base triangles. Said bisector lines are marked on the FIG. 1 as AD and AD′. In case of rectangular and polygonal prisms, abovesaid numerical values are largely represented by the length of the lines, dividing cross-sections (bases) of aforesaid three-dimensional objects into two equal parts.

Prismatic elements of such size are practically non-detectable by naked eye. Total reflectance of an exemplary, PGA derived element 10, whose length along AD/A′D′ lines is about 425 μm, constitutes about 97.4%, whereas even metallic surfaces reflect only 95% incident light at best. Tensile strength for such element 10 is measured to be 34.5 MPa, whereas deformation and melt temperature values constitute 124° C. and 133° C., respectively. Experimentally obtained technical characteristics, provided in Table 1, confirm that PGA derived micro-prisms demonstrate potential as being utilized for production of safety reflectors integrated to wearing apparel.

TABLE 1
Technical characteristics for PGA derived micro-prismatic elements 10.

| | |
|---|---|
| Thickness | 425 micron |
| UVA Stability, 1000 hours (340 nm) | <0.5% Reflectance change |
| UVB Stability, 1000 hours (313 nm) | <0.5% Reflectance change |
| Thermal Stability, 2000 hours at | <0.5% Reflectance change |
| 80° C. | |
| Humidity Stability, 1000 hours at | <0.5% Reflectance change |
| 60° C. and relative humidity 95% | |
| Dirt Depreciation | Antistatic, does not attract dirt |
| Abrasion Resistance | 500 cycles Taber test, |
| | <0.5% Reflectance change |
| Chemical Resistance | Compatible with common cleaners |
| | including ammonia, 409, dilute |
| | bleach solution and alcohols |

In order to fulfill an objective of the invention, so as to impart retroreflectivity to a selected object or a number of selected objects, the retroreflective elements 10 may be exploited in a variety of ways, some of those are depicted below.

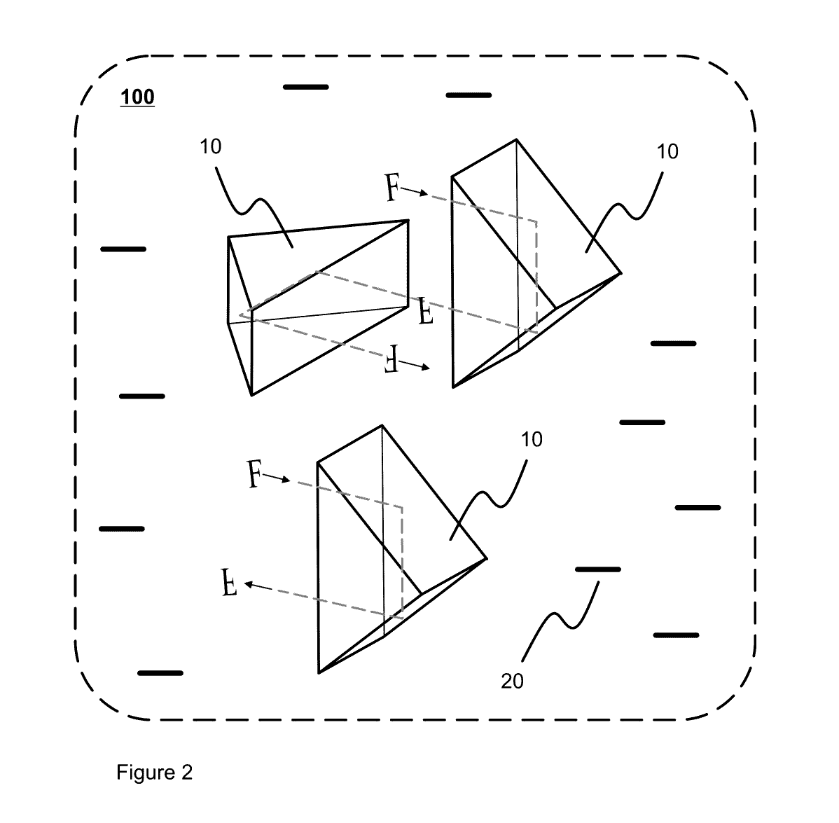

FIG. 2 schematically shows a reflective composite material 100 in accordance with some aspect of the invention. Composite 100 constitute a substantially liquid material and comprises a plurality of elements 10. Aforesaid material is structured as a composite material, composed of retroreflective micro-prismatic elements 10 and a binder 20. A binder may be represented by natural or biocompatible synthetic resin and selected from various polymeric adhesives and/or blends thereof. Examples may include, but are not limited to latex, both natural and synthesized, epoxy resins, biocompatible polyurethane and polycarbonate resins and the like.

It should be specified in this context, that the term “reflective”, when utilized with regards to a composite, a substance, a blend or a product, is utilized in this disclosure largely to indicate the presence of retroreflective micro-prismatic elements 10 therewithin and to point out that the nature of such reflectivity is not intrinsic, but acquired. In opposite, the terms “retroreflective” and/or “reflective” utilized herein with regards to elements 10 indicate intrinsic reflectivity thereof, since it is of general knowledge that prism per se possesses retroreflective properties, i.e. is capable of reflecting incident light and, in particular, to immediately return light back to a light source without diffusing it.

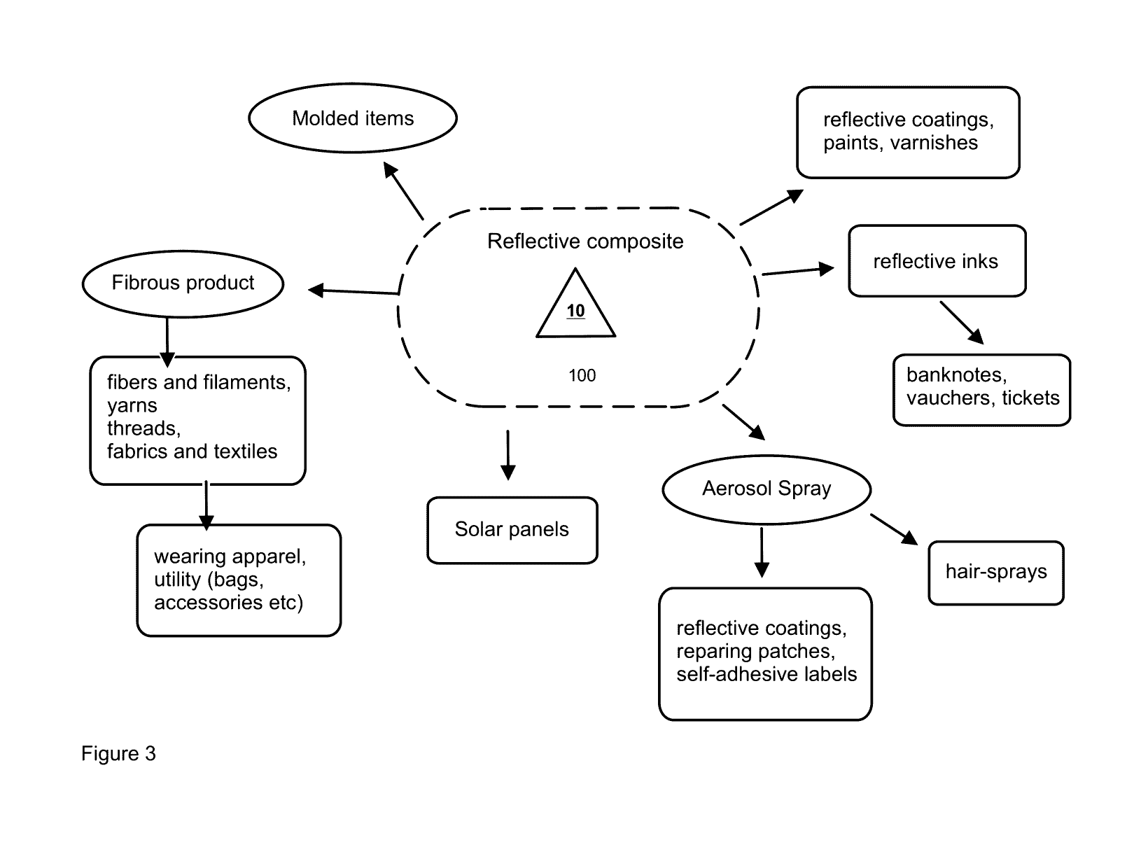

The reflective composite 100 is further processed in an application dependent manner to obtain a variety of reflective products. In order to obtain a reflective product the composite 100 may be utilized per se or it can be admixed with a suitable material, selected to optimize the properties of said composite 100 with regards to a particular application. A number of basic product groups may be identified in this context, such as a fibrous product and a flowing product, encompassing those suitable for application by spraying, spreading, printing, casting, molding, pressing and the like. One of the most important features of the invention is that the product obtained herewith may be provided in solid or fluid physical states, wherein by the term “fluid” we refer to either a substantially liquid, flowing compound suitable for surface application by spreading or layering, or the same in the form of an aerosol spray. These basic products may further be utilized to either produce a vast selection of utility items with imparted retroreflectivity or to render retroreflective otherwise conventional items. FIG. 3 schematically illustrates a variety of products, obtainable from the reflective composite 100.

Production of the fibrous product is preferably adjusted to fit main processes utilized in the textile industry. Fibrous product may thus be provided in the form of a fiber strand, a filament, a yarn or any type of thread, cord, rope or cable. Since fibers and filaments constitute primary units in the production of textiles, incorporation of the retroreflective micro-prismatic elements 10 into a staple fiber strand or into a filament has been advantageously implemented. In order to produce reflective fibers and/or filaments, meaning herein a plurality of aforesaid components with the retroreflective micro-prismatic elements 10 incorporated into each of them, the composite material 100 containing the elements 10 is advantageously admixed into a polymeric material or blend utilized for the production of textile fibers/filaments, which polymeric material/blend is further processed in a typical for textile industry manner. In some embodiment the binder composition of the material 100 may be adjusted such that composite 100 per se may be utilized for initial stages of fiber production. In this manner the composite material may be dosed to polymeric blend utilized for production of synthetic fiber, such as rayon, nylon and the like.

In either case, the reflective composite 100 or blend thereof may be processed by any method common for textile industry to form a staple fiber strand or a filament.

Filaments consist of very long, thin cylinders of extruded material, either in single strands (monofilament) or in grouped multiple strands (multifilament). Staple fibers are generally much shorter lengths of material 25 to 180 mm in length, manufactured, in case of synthetic fibers, by various spinning and/or extrusion methods.

Fiber strands and filament thus obtained may further be utilized for fabrication of yarn. In simplest case a single-spun (one-ply or “single”) yarn is produced, composed of several staple fiber strands held together by a twist (“spun”), or of extruded filaments, which may be monofilaments or several filaments grouped or twisted together.

The reflective fiber once obtained may further be introduced into the process of textile manufacturing at any stage thereof. As a result, in addition to entirely reflective single yarn, the same with varying reflectivity may be produced, wherein the reflective staple fibers or filaments are twisted or grouped together with non-reflective natural and/or synthetic fibers and filaments.

Furthermore, aforementioned single yarns may be utilized for the production of plied yarns, composed of two or more single yarns twisted together Plied yarn may therefore contain at least one reflective strand therewithin. Two or more reflective fiber strands may also be twisted together to obtain a yarn with higher degree of reflectivity. Plied yarns are commonly used for further production of threads, ropes, cords and cables. For example, a cabled yarn consists of two- or more plied yarns, twisted together; whereas a sewing thread consists of plied or cabled yarn. Also a so called gimped yarn may be produced, consisting of an untwisted, core yarn, around which another yarn or filament is wrapped.

In addition to fabricating single-spun and/or plied yarn, the reflective composite 100 may be utilized to produce core-spun yarn, which is generally composed of a mono- or multifilament core portion, around which fibers are wrapped. Reflective composite 100 may be utilized for the production of a filamentous core portion, for the production of fiber strands surrounding the core portion, or both. Around the reflective core portion any natural and/or synthetic fiber may still be twisted. Any combination of reflective and non-reflective core and fibrous “sheath” portions are possible, thus allowing “fine tuning” reflectivity levels of the core-spun yarn.

The composite material containing retroreflective micro-prismatic elements 10 preserve its reflective properties also upon coloration, thus enabling production of dyed fibers and therefore dyed items derived therefrom.

For those skilled in the art it is clear, that the reflective fibers and/or reflective filaments, obtained from the composite material 100 provided with a plurality of retroreflective elements 10, may be utilized for the production of practically any type of yarn. Reflectivity of a thread, cord, rope or cable product, further obtainable from said yarns, may be easily adjusted by varying a number of reflective fibers therewithin, for example.

Once obtained a reflective yarn may be utilized for production of practically any kind of textile items, including fabricating of plain, textured and decorated fabrics, both knit and woven, technical fabrics, lace, various braids, ribbons, stripes, trims and ornaments as well as for production of threads for sewing, embroidery, crocheting or knitting. Upon industrial textile weaving or knitting processes reflective threads may be arranged to form reflective patterns, including the ones as utilized for Jacquard weave.

Aforesaid reflective textiles or textiles with reflective patterns may be utilized for the production of wearing apparel, including headwear, beach- and underwear, gloves, pantyhose and socks, as well as any textile parts for the footwear. For example outdoor clothes and headwear may be fabricated such, to contain readily weaved/knitted reflective patterns therewithin. This eliminates the necessity of attaching safety reflectors by sewing or gluing, normally implemented as separate operations during manufacturing process. Any other textile accessory may be manufactured in similar manner, including, but not limited to belts, scarves, shawls, headbands and the like.

Reflective textiles or threads may be potentially useful for the production and decoration of home textiles, such as linens, curtains, canvas, furniture covers, coverlets and the like.

Referring back to basic product groups, obtainable on the basis of the composite material 100 comprising a plurality of the retroreflective micro-prismatic elements 10, a flowing product will be described next.

Flowing product may in turn be provided in the form of an aerosol spray and in the form of a substantially liquid product, suitable for further application by spreading, layering, printing and the like. The term “flowing” also encompasses products, obtainable by casting, molding and/or pressing; i.e. whose fabrication generally involves changes in physical state via solidification. Flowing product may be obtained by 1) rendering the composite material 100 itself suitable for aforesaid applications by admixing thereto supplementary additives, e.g. for optimizing or imparting desired characteristics, such as rigidness or elasticity; 2) admixing the composite material in a dosed manner into an appropriate blend, solution or mass and further processing the reflective product thus obtained. Mentioned methods are application dependent and differ by the amount of composite 100 required therefor.

For those skilled in the art it is clear, that a vast amount of utility and decoration items, packages, boards and panels with imparted retroreflectivity may be obtained by processing a substantially liquid reflective product by aforesaid methods. One of the useful applications includes admixing of the composite 100 with the materials utilized for making pavements and roadway coverings, thus obtaining a reflective road surface. The composite 100 may also be admixed to compositions used for road markings

The composite material 100 may be admixed to moldable polymers; thereby a variety of reflective items may be manufactured by molding or casting into forms. In this manner fully biodegradable plastic materials, having reflective properties, may be produced, such as various disposable items, like plastic bags, for example. The composition of the exemplary composite material 100, intended for further admixing with moldable polymers, is therefore adjustable such that biodegradability rate thereof will match the same of the moldable polymer.

Moreover, the composite material 100, comprising a plurality of the retroreflective elements 10, may be utilized for the production of reflective inks for printing reflective patterns on a variety of surfaces. The properties of such composite material derived ink may be adjusted for printing on textiles, plastics, paperboards, wood, metals and the like. One of the potential applications includes marking banknotes, tickets, vouchers and official documents; identification systems thereof may be adapted to recognize reflective prints.

Another vast application area for the flowing product obtainable from the composite material 100 is represented by production of reflective coatings. Said coatings may be solid and applied by casting or layering, liquid or provided in an aerosol form. Liquid coatings may be provided in the form of various paints, varnishes or lacquers. Application areas thereof range from the production of traffic signs to decorative cosmetics industry, e.g. production of nail varnishes. Due to biodegradability of the reflective elements 10, the composite 100 based coatings in particular suit for fabricating of disposable items, and therefore may be utilized for producing entertainment items for parties or gift paper, for example. The same refers to printed solutions.

The composite material, comprising a plurality of the retroreflective elements 10, may be rendered for utilization as an aerosol spray. By adjusting size of the retroreflective micro-prismatic elements 10 and/or concentration thereof per volume unit of the binding solution a selection of aerosol mists of retroreflective particles may be created. Reflective spray may be colorless or additionally supplied with a color pigment. As already mentioned elsewhere in this document, the composite material containing retroreflective micro-prismatic elements 10 preserve reflective properties thereof also upon dyeing. Colorless solution is advantageous since it may be applied to practically any item of wearing apparel, without altering its visual appearance. From the other hand, colored sprays may be utilized for decorative purposes. One of the possible applications includes utilization of the reflective aerosol spray as hair spray, for example.

The reflective spray product may further by utilized for manufacturing safety reflectors in the form of self-adhesive labels or patches for repairing clothes. Colorless or colored spray may be applied onto a suitable surface, such as an upper face of a self-adhesive sheet, tape or film, or, in case of repairing patch, onto a sheet of durable, abrasion resistant material, such as Cordura®, leather and the like. Repairing patches may be manufactured to be applicable by sewing or ironing. Self-adhesive labels may be manufactured to be applicable to various surfaces, such as textiles, leather, plastics or metals so to be applied directly onto clothes, bags, rucksacks, bicycles and the like.

Both flowing and fibrous product solutions may be applied directly to a variety of items or may be deposited under a protective membrane, forming a reflective layer for a reflective film.

In some embodiment, retroreflective micro-prismatic elements 10 may be admixed directly to an appropriate solvent, blend or mass to be further processed as disclosed above.

In some embodiment, retroreflective micro-prismatic elements 10 may be utilized for the production of solar panels. Such solar panels are preferably produced as flexible thin-film items, suitable for integration into garments, for example. Aforesaid items may be rendered to combine retroreflective properties with capability to capture solar energy.

Concerning products, manufactured on the basis of the retroreflective elements in accordance with the invention, and a variety of utility, decoration and wearing apparel items produced while exploiting the possibilities offered by the invention, different configurations, dimensions and shapes thereof may be naturally cleverly combined by a skilled person to come up with new variations of the same basic embodiment. The invention and its embodiments are thus not limited to the examples described above; instead they may generally vary within the scope of the appended claims.

1-25. (canceled)

26. A retroreflective element (10) in the form of a micro-prism, wherein said element (10) is produced from bio-based and biodegradable plastic polymers.

27. The retroreflective element (10) of claim 26 in the form of the micro-prism, comprising two bases in the form of equal polygons similarly oriented in parallel planes.

28. The retroreflective element (10) of claim 27 in the form of a triangular micro-prism, comprising two bases in the form of identical triangles ABC and A′B′C′ similarly oriented in parallel planes to form flat sides faces AA′C′C, AA′B′B and BB′C′C in the form of parallelograms, wherein at least two adjacent side faces have equal dimensions.

29. The retroreflective element (10) of claim 26, wherein said element is dimensioned within the micrometer range of 0.01-1000, preferably 0.1-500.

30. The retroreflective element (10) of claim 26, wherein the bio-based and biodegradable plastic polymer is selected from the group consisting of polylactic acid (PLA), polyglycolic acid (PGA), poly-lactic-co-glycolic acid (PLGA) and derivatives and/or copolymers thereof.

31. A reflective composite material (100), comprising a reinforcing component and a binder (20), wherein the binder (20) is natural or biocompatible synthetic resin, and wherein the reinforcing component is represented by a plurality of retroreflective prismatic elements (10), as defined in claim 26, whose disposition within the binder (20) is random.

32. A method for producing a reflective product, selected from the group consisting of a fibrous product and a substantially liquid product suitable for application by one of the methods selected from spraying, spreading, printing, casting, molding or pressing, said method comprises: obtaining the reflective composite material (100), as defined in claim 31, and admixing said reflective composite material (100) in a dosed manner into a suitable solvent, blend or composition, utilized for the conventional manufacturing of said product.

33. The method of claim 32 for producing a reflective fibrous product in the form of a staple fiber and/or a filament, comprising the steps of: (a) admixing the composite material (100) into a polymeric material or blend, utilized for the conventional production of textile fibers and/or filaments, in a dosed manner; and (b) further subjecting the resulted mixture or blend to the processes of spinning and/or extrusion.

34. The method of claim 33 for producing a reflective fibrous product in the form of a single yarn, comprising the steps of: (a) admixing the composite material (100) into a polymeric material or blend, utilized for the conventional production of textile fibers or filaments, in a dosed manner; (b) subjecting the resulted mixture blend to the processes of spinning or extrusion to obtain a plurality of staple fibers or filaments; and (c) further gathering thus obtained staple fibers or filaments to bunches composed of several staple fibers held together by a twist or of several filaments grouped or twisted together.

35. The method of claim 33 for producing a reflective fibrous product in the form of a plied yarn, comprising the steps of: (a) admixing the composite material (100) into a polymeric material or blend, utilized for the conventional production of textile fibers or filaments, in a dosed manner; (b) subjecting the resulted mixture blend to the processes of spinning or extrusion to obtain a plurality of staple fibers or filaments; (c) gathering thus obtained staple fibers or filaments to bunches composed of several staple fibers held together by a twist or of several filaments grouped or twisted together to obtain a single yarn; and (d) further twisting at least two single yarns in a direction opposite to that utilized at the previous step (c).

36. The method of claim 33 for producing a reflective fibrous product in the form of a core-spun yarn, comprising the steps of: (a) from the composite material (100) admixed into a polymeric material or blend and subjected to the process of extrusion obtaining a core portion of the core-spun yarn consisting of the continuous extruded filament; (b) from the composite material (100) admixed into a polymeric material or blend and subjected to the to the process of spinning obtaining a sheath portion of the core-spun yarn consisting of a number of staple fibers, and (c) wrapping staple fibers, obtained at step (b), around the filamentous core portion, obtained at step (a).

37. A reflective fibrous product in the form of a single yarn, a plied yarn or core-spun yarn, comprising the reflective composite material (100), as produced by the method of claim 34.

38. The reflective fibrous product of claim 37, further comprising any conventional, natural or synthetic fiber-, filament- or yarn component, integrated to or combined with the reflective same in any combination possible.

39. The reflective fibrous product of claim 38, configured as a thread for sewing, embroidery, crocheting or knitting, a cord, a rope or a cable.

40. A reflective textile article, produced by weaving or knitting the fibrous product as defined in claim 37 and comprising the reflective composite material (100), selected from the group consisting of plain and textured woven fabric, plain and textured knit fabric, technical fabric, lace, braids, ribbons, stripes, trims and ornaments.

41. A reflective article of wearing apparel, manufactured from the reflective textile article of claim 40, selected from the group consisting of garments, headwear, beach- and underwear, gloves, pantyhose and socks, textile parts for the footwear, and textile accessories, such as belts, scarves, shawls, headbands and the like.

42. The method of claim 32 for producing a reflective molded product from the reflective composite (100) by blending the reflective composite (100) with a substantially liquid, moldable polymer and further subjecting the resulted blend to a molding process including, but not limited with injection molding, extrusion molding, compression molding and matrix molding.

43. The method of claim 32 for producing a substantially liquid reflective product selected from the group consisting of inks, paints, dyes, varnishes and coatings by admixing the reflective composite (100) into an appropriate solvent, dye, paint, varnish or coating composition.

44. A substantially liquid reflective product selected from the group consisting of inks, paints, dyes, varnishes and coatings, produced by the method of claim 43 and comprising the reflective composite material (100).

45. The substantially liquid reflective product of claim 44, in the form of reflective ink, comprising the reflective composite material (100), for printing on banknotes, vouchers, tickets and official documents.

46. The method of claim 32 for producing a reflective product in the form of aerosol spray, by dispensing the reflective composite (100) in air or inert gas.

47. A reflective product in the form of aerosol spray, produced by the method of claim 46 and comprising the reflective composite material (100) for generating reflective coatings on durable and/or self-adhesive supports, including, but not limited with repairing patches, self-adhesive labels and stickers.
